(19) United States
(12) Patent Application Publication
(10) Pub. No.: US 2004/0085873 A1
(43) Pub. Date: May 6, 2004

(54) Single-speed mass memory storage device with continuously variable read channel and method

(76) Inventors: Jeffrey G. Reh, Longmont, CO (US); Tracy D. Harmer, Erie, CO (US); Curtis H. Bruner, Niwot, CO (US)

Correspondence Address: TEXAS INSTRUMENTS INCORPORATED, P O BOX 655474, M/S 3999, DALLAS, TX, 75265

(21) Appl. No.: 10/696,857

(22) Filed: Oct. 30, 2003

Related U.S. Application Data
(62) Division of application No. 09/588,088, filed on Jun. 6, 2000.

(51) Int. Cl. G11B 15/46

(52) U.S. Cl. 369/47.28; 369/53.29; 360/73.03

(57) ABSTRACT

A mass memory storage device for reading data stored on a mass memory storage medium on which the data is stored at a substantially uniform density including a support arrangement configured to receive and support the medium. A drive arrangement is operatively connected to the support arrangement such that the drive arrangement rotates the medium at a substantially constant rotational speed when the device is operated in its intended way. A read head for reading the data stored on the medium is positioned adjacent to the medium with the read head being movable relative to the medium. A read channel arrangement for processing the data read by the read head is operatively connected to the read head. The read channel arrangement has a substantially continuously variable read channel data processing rate which varies according to the rate at which the read head reads the data from the medium. In a preferred embodiment, the device is a CD drive.

### FIELD OF THE INVENTION

The present invention relates generally to mass memory storage devices. More particularly, the present invention relates to a single rotational-speed mass memory storage device, such as a CD drive, which has a substantially continuously variable rate or frequency read channel.

### BACKGROUND OF THE INVENTION

In the computer industry, large capacity mass memory storage devices, such as CD drives, are becoming more and more common. Many new personal computer systems currently sold include a CD drive packaged as part of the system. This continuously increasing demand results in a highly competitive market for CD drives that are more cost-effective and offer higher performance. Currently, 32× and 40× speed CD drives are readily available. However, as the speed of the CD drive is further increased, it becomes more and more difficult to provide a CD drive arrangement capable of the precise speed variations necessary in order to operate a CD drive using the conventional approach to operating the CD drive.

As illustrated in FIG. 1, which schematically illustrates a standard format CD indicated by reference numeral 10, data is stored on a data storage surface 12. The data is stored along a spiral track or tracks 14 at a substantially uniform density. As the track or tracks spiral outward from the center of the CD to the periphery of the CD, the density of the data stored on the CD, i.e. the amount of data per unit length of track, remains the same. Therefore, more and more data is stored on the CD for each successive revolution of the spiraling track as the track spirals outward to the outer periphery of the CD. This approach makes efficient use of the storage space available on the CD. However, it creates the problem of having to vary the speed of rotation of the CD in order to provide a constant data read rate as required by conventional CD drives. In order to read the data from the CD at a constant read rate using a read head positioned adjacent to the CD, the rotational speed of the CD must be varied in proportion to the radial positioning of the data on the CD that is being read.

To date, conventional CD drives operate at continuously variable speeds which depend on the relative radial position of the data on the CD that is being read. As the read head of a conventional CD drive is moved radially along the CD to follow the spiral track, the speed at which the CD is rotated is varied in order to maintain a constant data read rate. As the read head is moved radially inward toward the center of the CD, the drive must increase the rotational rate in order to maintain a constant data read rate. This means that the drive must be capable of operating reliably within the range of speeds from the relatively slow rotational speed used to read the outer portions of the spiral track, up to the relatively high rotational speed used to read the inner portion of the spiral track. As mentioned above, as the speeds of CD drives are increased to offer improved performance, it becomes more and more difficult to produce a drive that is precise enough to provide the reliable variations in speed that are necessary to obtain a constant read rate. Furthermore, these high precision variable speed drives which are needed for the faster CD drives add substantially to the costs of producing a high-speed CD drive.

Other mass memory storage devices, such as hard disk drives, have utilized drives which are operated at a constant speed. However, these drives utilize either a constant data read rate or a stepped data read rate. In the case of a constant data read rate, which was common on early hard disk drives, the data storage density varies relative to the radial position of the data on the disk. This approach substantially underutilizes the data storage space available on the disk since the data is spread over a much larger area in the outer portions of the disk compared with the inner portions of the disk. In the case of a stepped data read rate which is currently more common, the disk is subdivided into concentric portions or zones. Each zone utilizes a different data read rate. This approach improves the utilization of the storage space by storing data at a higher density in the outer zones; however, it still underutilizes the space available. Also, because of the addressing methods and formats typically used for hard disk drives having zones and because of industry standards established by the hard disk drive and computer industry, the total number of zones that may be used is limited.

### SUMMARY OF THE INVENTION

The present invention provides a mass memory storage device, such as a CD drive, which utilizes a substantially constant speed drive arrangement and a continuously variable read channel arrangement so as to operate on, for example, standard CDs. In the case of a CD drive, this approach substantially simplifies the drive arrangement which significantly reduces the cost of providing the device. It also improves the access time of the CD drive by negating the requirement for the spindle system to change its rotational speed for every seek. In the case of a hard disk drive or a floppy disk drive, this approach maximizes the memory storage capacity of a given disk by allowing the data to be stored at a uniform density throughout substantially the entire memory storage space of the disk.

As will be described in more detail hereinafter, there is disclosed herein a mass memory storage device, such as a CD drive, for reading data stored on a mass memory storage medium. The mass memory storage device includes a support arrangement configured to receive and support the mass storage medium which stores data at a substantially uniform density. A drive arrangement is operatively connected to the support arrangement such that the drive arrangement rotates the medium at a substantially constant rotational speed when the device is operated in its intended way. A read head for reading the data stored on the medium is positioned adjacent to the medium with the read head being movable relative to the medium such that when the mass memory storage medium is rotated at the constant speed, the data is read at a variable rate. A read channel arrangement for processing the data read by the read head is operatively connected to the read head. The read channel arrangement is configured to operate at a substantially continuously variable read channel processing rate which varies according to the rate at which the read head reads the data from the medium as the medium is rotated at the constant speed.

In one preferred embodiment of the present invention, the device is a CD drive capable of reading a standard format CD in which the data is stored at a substantially uniform density along a spiral track. In this embodiment, the read head is moved radially as the drive arrangement rotates the CD at a substantially constant rotational speed such that the read head follows and reads data from the spiral track. The read channel data processing rate is varied in direct relationship with the radial position of the read head. This allows the read channel arrangement to process the data read by the read head at the rate at which the data is being read by the read head from the spiral track of the CD.

In another embodiment of the invention, a computer system includes a mass memory storage device for reading data stored on a data storage surface of a mass memory storage medium which stores data at a substantially uniform density. The mass memory storage device includes a housing that receives and supports the mass memory storage medium. A drive assembly is operatively connected to the housing such that when the device is operated in its intended way, the drive assembly rotates the medium at a substantially constant rotational speed. A read head for reading the data from the data storage surface of the medium is movably supported by the housing adjacent to the data storage surface of the medium, thereby causing the read head to read the data stored on the medium such that when the mass memory storage medium is rotated at the constant speed, the data is read at a variable rate. A read channel arrangement is operatively connected to the read head. The read channel arrangement includes a read channel processor which processes the data read by the read head. The read head processor has a continuously variable data processing rate that is varied according to the rate at which the read head reads the data from the medium.

A method of reading and/or storing data on a mass memory storage medium is also disclosed. In this method, a mass memory storage medium, which stores data at a substantially uniform density, is supported for rotation, and the medium is rotated at a substantially constant speed. Using a read/write head, data is read/written by positioning the read/write head adjacent to a desired portion of the medium as the medium is rotated at the constant speed and moving the read/write head relative to the medium as the medium is rotated and as the data is read/written. Using a write controller having a continuously variable write rate, data is written to the medium at a rate that depends on the position of the write head such that the data is written having a substantially uniform density throughout substantially the entire usable memory storage area of the medium. Using a read head processor having a continuously variable processing read rate, the data being read is processed by varying the processing rate according to the rate at which the read head reads the data from the medium.

A formatted magnetic mass memory storage disk medium is also disclosed. The medium includes a magnetic memory storage material capable of storing data. A substrate supports the memory storage material such that the memory storage material is arranged in a format in which the data is stored on the disk medium at a substantially uniform density throughout substantially the entire usable memory storage area of the disk medium. In a preferred embodiment, the format includes a spiral track, and the medium is a hard disk for use in a hard disk drive. Alternatively, in another embodiment, the medium is a floppy disk for use in a floppy disk drive.

### BRIEF DESCRIPTION OF THE DRAWINGS

FIG. 1 is a schematic diagram of a CD illustrating the standard format used for a conventional CD;

FIG. 2 is a schematic diagram of a computer system including a mass memory storage device in accordance with the present invention;

FIG. 3A is a flow chart illustrating the steps involved in reading data from a mass memory storage medium in accordance with the present invention;

FIG. 3B is a flow chart illustrating the steps involved in writing data to a mass memory storage medium in accordance with the present invention; and

FIG. 4 is a schematic diagram of a magnetic mass memory storage disk in accordance with the present invention.

### DETAILED DESCRIPTION OF THE PRESENT INVENTION

The present invention will now be described in detail using the examples of several presently preferred embodiments. However, it should be understood that the invention may be embodied in many different forms without departing from the spirit or scope of the invention. Therefore, the examples given are to be considered as illustrative of the principles of the invention and are not intended to limit the invention to the specific details described.

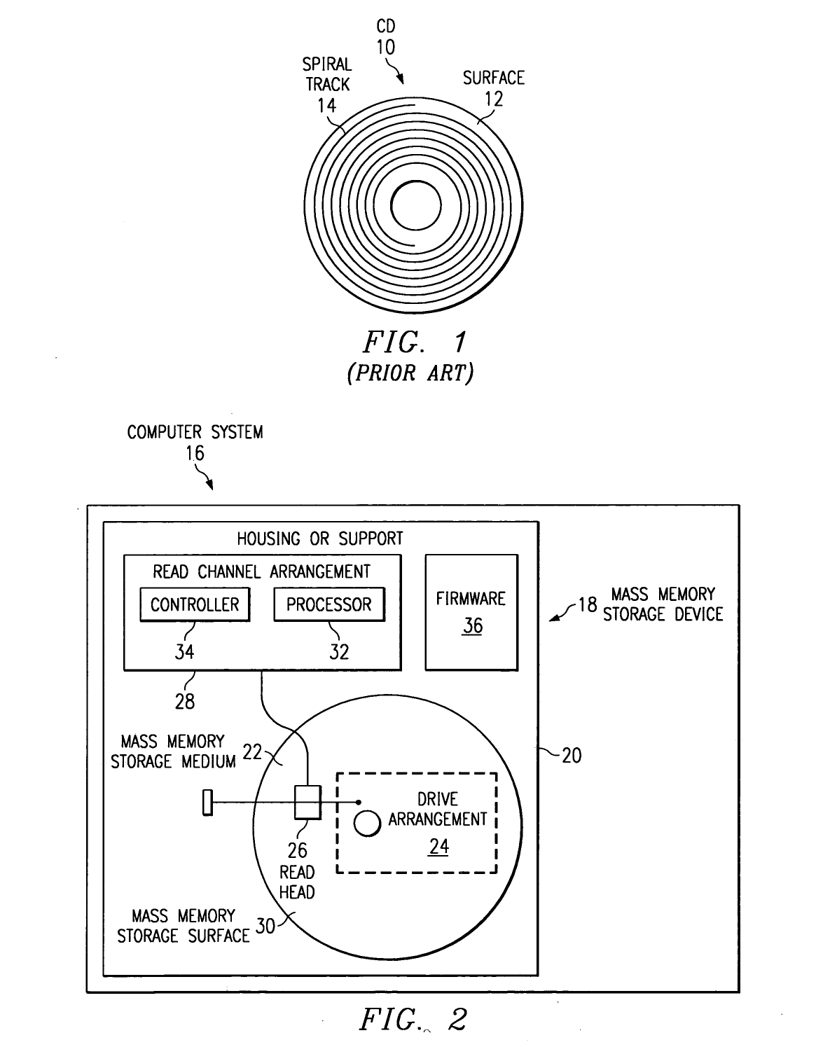

Referring initially to FIG. 2, a computer system in accordance with the invention and generally designated by reference numeral 16 will be described. Computer system 16 may be any suitable computer system or subsystem which utilizes a mass memory storage device to store data. This includes, but is not limited to, personal computers, work stations, computer networks, main frame computers, television I/O applications, audio/video applications, computer subsystems utilized in equipment or machinery, or any other computer application. Computer 16 includes a mass memory storage device 18 operatively connected to computer 16. Mass memory storage device 18 is illustrated as being internally mounted within computer 16; however, as is know, it may alternatively be an external peripheral device, or it may be part of a network of interconnected computers and peripheral devices.

Mass memory storage device 18 includes a housing or support arrangement 20 for receiving and supporting for rotation a mass memory storage medium or disk 22. Support arrangement 20 also operatively supports a drive arrangement 24, a read head 26, and a read channel arrangement 28. In accordance with the invention, drive arrangement 24 is configured to rotate disk 22 at a substantially constant rotational speed. Drive arrangement 24 may take a wide variety of forms known in the art, such as a direct drive motor, a motor and gear or pulley drive arrangement, spindle motor, or any other drive arrangement which causes the disk to be rotated at a substantially constant rotational speed.

Also in accordance with the invention, mass memory storage medium or disk 22 is a medium in which the data is stored on the disk at a substantially uniform density throughout the entire memory storage area of the disk. As described in the background with reference to FIG. 1, a conventional CD is an example of such a medium. However, as will be described in more detail hereinafter, disk 22 and device 18 may take the form of a wide variety of mass memory storage mediums and devices including a hard disk for use in a hard disk drive, a floppy disk for use in a floppy disk drive, a magneto storage, or a variety of other optical and/or magnetic storage media for use in corresponding devices. The present invention would apply to any such mass memory storage media and devices so long as the memory storage medium used by the device is a disk-type medium in which the data is stored on the medium at a substantially uniform density throughout substantially the entire memory storage area of the medium. In the case of a hard or floppy disk drive, and in the case of some CD drives, device 18 would include both read and write capabilities.

As is known in the art, read head 26 is movably supported adjacent to a memory storage surface 30 of disk 22 such that read head 26 may be moved relative to surface 30 in order to read and/or write data to and from disk 22. Read head 26 may be any conventional, readily providable read head including optical read heads and magnetic read heads. Typically, read head 26 would be mounted for movement radially relative to the disk as indicated in FIG. 2. However, alternatively, the read head may be mounted for movement along an arc which allows the read head to be positioned adjacent all of the usable memory storage area of the disk as the disk is rotated. Furthermore, other configurations for moving the read head relative to the disk would fall within the scope of the invention so long as the configuration would allow the read head to be moved along the surface of the disk such that the read head may be positioned adjacent all of the usable memory storage area of the disk as the disk is rotated.

As illustrated in FIG. 2, read channel arrangement 28 is operatively connected to read head 26. In accordance with the invention, read channel arrangement 28 includes a processor 32 and/or a controller 34 which are capable of operating at continuously variable data read and/or write rates. A variety of suitable and readily providable processors and controllers may be utilized. These processors and/or controllers and others like them may be caused to operate at a continuously variable rate by using firmware 36 which senses the read rate of the read head and changes the processing rate of processor 32 to correspond to the read rate.

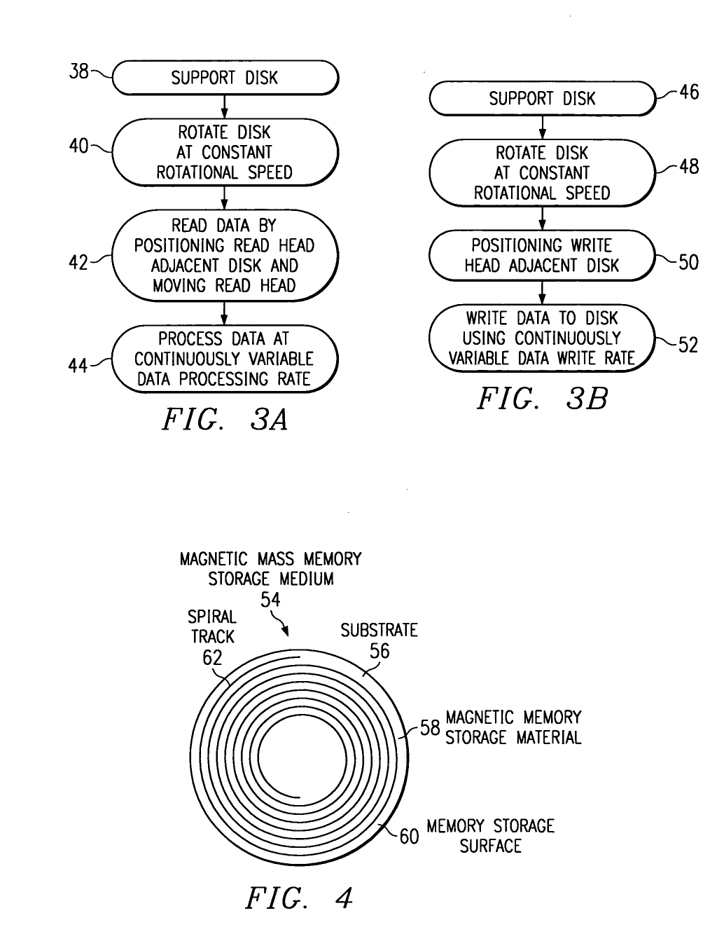

Referring now to FIGS. 3A and 3B, the operation of a mass memory storage device in accordance with the present invention will now be described. FIG. 3A illustrates the steps involved in reading data from a mass memory storage medium such as disk 22. Initially, as indicated in step 38, the medium is supported for rotation. The medium may be a removable disk such as a CD, a floppy disk, or a removable hard disk. Alternatively, the medium may be a permanently mounted medium as would be the case for a more traditional style of hard disk drive.

As indicated in step 40, the medium is rotated at a substantially constant rotational speed. In step 42, a read head is positioned adjacent to the memory storage surface of the medium. The read head is moved relative to the surface of the medium while the medium is rotating at a constant rotational speed such that the read head reads data from the medium at a varying data read rate. Finally, in step 44, the data is processed by a read channel processor having a continuously variable data processing rate. In accordance with the invention, the data processing rate of the read channel processor is varied according to the data read rate of the read head.

Referring to FIG. 3B, data is written to the medium in a process similar to that described above for reading data from the medium. Initially, the medium is supported for rotation as indicated in step 46. In step 48, the medium is rotated at a substantially constant rotational speed. As indicated in step 50, as the medium is rotated at the constant speed, the write head is positioned adjacent to the portion of the medium to which data is to be written. The write head is also moved relative to the data storage surface of the medium as the data is written. In accordance with the invention and as shown in step 52, a controller having a variable write rate is used to cause the data to be written to the medium at a substantially continuously variable write rate such that the data is stored on the medium at a substantially uniform density regardless of the relative position at which the data is stored on the medium.

In a preferred embodiment, the device of the present invention takes the form of a CD drive. In this situation, a standard CD may be used, since as described above, conventional CDs have data stored on the CD in a spiral track with the data being stored at a uniform density. However, if the device takes the form of a hard disk drive, a floppy disk drive, or another variation of these devices using magnetic media to store data (i.e. a removable hard disk drive), then in accordance with the invention, the medium must be a specially formatted medium designed to have a uniform data storage density.

Referring now to FIG. 4, a magnetic memory storage medium or disk in accordance with the invention and generally indicated by reference numeral 54 will be described. Medium 54 takes the form of a disk medium such as a hard disk for use in a hard disk drive, a floppy disk for use in a floppy disk drive, or a variation of these media such as a removable hard disk for use in a removable media hard disk drive. Disk 54 includes a substrate 56 which supports a magnetic memory storage material 58 on a memory storage surface 60. Any suitable and readily providable magnetic memory storage material may be used as memory storage material 58.

In accordance with the invention, memory storage material 58 is configured on memory storage surface 60 such that it is formatted to store data at a substantially uniform density throughout substantially the entire memory storage area of disk 54. In one preferred embodiment, the formatting configuration takes the form of a spiral track 62 which spirals from the outer periphery of the disk inward to the central portion of the disk. Although only one specific configuration is illustrated, it should be understood that the configuration may vary so long as the data is stored at a uniform density. For instance, the configuration may be a spiral track spiraling in either the clockwise or counterclockwise direction. Alternatively, the configuration may be a multiplicity of concentric circular tracks with all of the circular tracks having the same uniform data storage density.

Although the invention has been described as being a CD drive, a hard disk drive, and a floppy drive, it should be understood that the present invention would equally apply to other similar drives and memory storage media. For instance, a wide variety of removable media drives which have some of the characteristics of hard disk drives and some of the characteristics of floppy disk drives are readily available. The present invention would equally apply to these various drives so long as the data is stored on the associated memory storage medium at a substantially uniform density and so long as the medium is rotated at a substantially constant rotational speed thereby requiring the read channel to operate at a continuously variable processing rate. Therefore, the present examples are to be considered as illustrative and not restrictive, and the invention is not to be limited to the details given herein, but may be modified within the scope of the appended claims.

1. A mass memory storage device comprising:
a support arrangement configured to support a mass memory storage medium which stores data at a substantially uniform density;
a drive arrangement operatively connected to the support arrangement such that the drive arrangement rotates the mass memory storage medium at a substantially constant rotational speed when the mass memory storage device is operated in its intended way;
a read head for reading the data stored on the mass memory storage medium, the read head being positioned adjacent to the stored data on the medium and the read head being movable relative to the medium such that when the mass memory storage medium is rotated at the constant speed, the data is read at a variable rate; and
a read channel arrangement for processing the data read by the read head, the read channel arrangement having a substantially continuously variable read channel data processing rate which varies according to the rate at which the read head reads the data from the mass memory storage medium.

2. A device according to claim 1, wherein the device is a CD drive and the medium is a CD.

3. A device according to claim 1, wherein the CD is a standard format CD in which the data is stored at a substantially uniform density along a spiral track.

4. A device according to claim 3, wherein the read head is moved radially as the drive arrangement rotates the CD at a substantially constant rotational speed such that the read head follows and reads data from the spiral track.

5. A device according to claim 3, wherein the read channel data processing rate varies in direct relationship with the radial position of the read head, thereby allowing the read channel arrangement to process the data read by the read head at the rate at which the data is being ready by the read head from the spiral track of the CD.

6. A device according to claim 1, wherein the device is a hard disk drive.

7. A device according to claim 6, wherein the medium is a magnetic memory storage medium having the data stored on the medium at a substantially uniform density over substantially the entire memory storage area.

8. A device according to claim 7, wherein the medium has a data storage format including a spiral track.

9. A device according to claim 1, wherein the read head is an optical read head.

10. A device according to claim 1, wherein the read head is a magnetic read head.

11. A device according to claim 1, wherein the device is a floppy disk drive.

12. A device according to claim 11, wherein the medium is a magnetic memory storage medium having the data stored on the medium at a substantially uniform density over substantially the entire memory storage area.

13. A device according to claim 12, wherein the medium has a data storage format including a spiral track.

14. A computer system including a mass memory storage device for reading data stored on a data storage surface of a mass memory storage medium, the mass memory storage device comprising:
a housing that receives and supports a mass memory storage medium which stores data at a substantially uniform density;
a drive assembly operatively connected to the housing such that when the device is operated in its intended way, the drive assembly rotates the medium at a substantially constant rotational speed;
a read head for reading the data from the data storage surface of the medium, the read head being movably supported by the housing adjacent to the data storage surface of the medium, thereby causing the read head to read the data stored on the medium such that when the mass memory storage medium is rotated at the constant speed, the data is read at a variable rate; and
a read channel arrangement operatively connected to the read head, the read channel arrangement including a read channel processor which processes the data read by the read head and which has a continuously variable data processing rate that is varied according to the rate at which the read head reads the data on the medium.

15. A computer system according to claim 14, wherein the device is a CD drive and the medium is a CD.

16. A computer system according to claim 14, wherein the device is a hard disk drive and the medium is a magnetic memory storage medium which has the data stored on the medium at a substantially uniform density over substantially the entire memory storage area.

17. A computer system according to claim 14, wherein the device is a floppy disk drive and the medium is a magnetic memory storage medium which has the data stored on the medium at a substantially uniform density over substantially the entire memory storage area.

18. A method of reading data stored on a mass memory storage medium, the method comprising the steps of:
supporting the mass memory storage medium having data stored on the medium at a substantially uniform density;
rotating the medium at a substantially constant speed;
using a read head, reading the data stored on the medium by positioning the read head adjacent to a desired portion of the medium and moving the read head relative to the medium as the data is read such that when the mass memory storage medium is rotated at the constant speed, the data is read at a variable rate; and
using a read head processor having a continuously variable processing rate, processing the data read by the read head by varying the processing rate according to the rate at which the read head reads the data on the medium.

19. A method according to claim 18, wherein the medium is a medium having data stored on the medium at a substantially uniform density selected from the group including (i) a CD having data stored optically on a data storage surface of the CD, (ii) a hard disk having data stored magnetically, and (iii) a floppy disk having data stored magnetically.

20. A method of storing data on a mass memory storage medium having a substantially uniform data storage density, the method comprising the steps of:
supporting the mass memory storage medium for rotation;
rotating the medium at a substantially constant speed;
using a write head, storing the data to the medium by positioning the write head adjacent to a desired portion of the medium while the medium is rotated at the constant speed and moving the write head relative to the medium as the data is stored; and
using a write head controller having a continuously variable data storing rate, storing the data on the medium by varying the data storing rate according to the position of the write head such that the data is stored at a substantially uniform density.

21. A method according to claim 20, wherein the medium is a medium selected from the group including (i) a CD having data stored optically on a data storage surface of the CD, (ii) a hard disk having data stored magnetically, and (iii) a floppy disk having data stored magnetically.

22. A formatted magnetic mass memory storage disk medium, the medium comprising:
a magnetic memory storage material capable of storing data magnetically; and
a substrate supporting the memory storage material, the memory storage material being arranged in a format in which the data is stored on the disk medium at a substantially uniform density throughout substantially the entire usable memory storage area of the disk medium.

23. A disk medium according to claim 22, wherein the format includes a spiral track.

24. A disk medium according to claim 22, wherein the medium is a hard disk for use in a hard disk drive.

25. A disk medium according to claim 22, wherein the medium is a floppy disk for use in a floppy disk drive.
